(19) United States
(12) Patent Application Publication
(10) Pub. No.: US 2020/0087535 A1
(43) Pub. Date: Mar. 19, 2020

(54) ACTIVE ENERGY RAY CURABLE COMPOSITION, STEREOSCOPIC MODELING MATERIAL, ACTIVE ENERGY RAY CURABLE INK, INKJET INK, ACTIVE ENERGY RAY CURABLE COMPOSITION CONTAINER, TWO-DIMENSIONAL OR THREE-DIMENSIONAL IMAGE FORMING APPARATUS, TWO-DIMENSIONAL OR THREE-DIMENSIONAL IMAGE FORMING METHOD, CURED PRODUCT, AND PROCESSED PRODUCT

(71) Applicants: Hiroki KOBAYASHI, Kanagawa (JP); Mie YOSHINO, Kanagawa (JP); Manabu ARITA, Kanagawa (JP)

(72) Inventors: Hiroki KOBAYASHI, Kanagawa (JP); Mie YOSHINO, Kanagawa (JP); Manabu ARITA, Kanagawa (JP)

(21) Appl. No.: 16/692,459

(22) Filed: Nov. 22, 2019

Related U.S. Application Data
(63) Continuation of application No. 15/155,379, filed on May 16, 2016.

(30) Foreign Application Priority Data
Jun. 1, 2015 (JP) 2015-111180

(51) Int. Cl. C09D 175/16; B41J 11/00; C08L 75/16; C09D 11/38; C09D 11/101; C08F 120/56; C09D 133/26; C09D 11/324; C08F 126/06; C09D 139/04; C08F 120/18; C09D 133/08; C08F 124/00; C09D 137/00; C08F 118/14; C08G 71/04

(52) U.S. Cl. CPC C09D 175/16; B41J 2/01; C08L 75/16; C09D 11/38; C09D 11/101; C08F 120/56; C09D 133/26; C09D 11/324; C08F 126/06; C09D 139/04; C08F 120/18; C09D 133/08; C08F 124/00; C09D 137/00; C08F 118/14; C08G 71/04; B41J 11/002

(57) ABSTRACT

An active energy ray curable composition including a polymerization initiator and a polymerizable compound is provided. When the active energy ray curable composition is formed into a cured film on a substrate under the specific condition, the cured film satisfies the following conditions (1) and (2):
(1) when the substrate is a polyethylene terephthalate substrate, the cured film on the substrate has a transmission density of from 1.5 to 3.0 that is measured with a transmission densitometer, and
(2) when the substrate is a polycarbonate substrate, the cured film on the substrate has a first length (L1) and a second length (L2) before and after a specific tensile test, respectively, and a ratio of L2/L1 ranges from 1.5 to 4.0.

### CROSS-REFERENCE TO RELATED APPLICATIONS

This patent application is based on and claims priority pursuant to 35 U.S.C. § 119(a) to Japanese Patent Application No. 2015-111180, filed on Jun. 1, 2015, in the Japan Patent Office, the entire disclosure of which is hereby incorporated by reference herein.

### BACKGROUND

### Technical Field

The present disclosure relates to an active energy ray curable composition, a stereoscopic modeling material, an active energy ray curable ink, an active energy ray curable composition container, a two-dimensional or three-dimensional image forming apparatus, a two-dimensional or three-dimensional image forming method, a cured product, and a processed product.

### Description of the Related Art

A decorating method is known, in which a coated film of an active energy ray curable composition is formed on a substrate and irradiated with an active energy ray and the resulting cured product and the substrate are subjected to stereoscopic molding at the same time. In stereoscopic molding, the cured product generally needs to be stretchable. As the cured product stretches, the transmission density thereof lowers.

### SUMMARY

In accordance with some embodiments of the present invention, an active energy ray curable composition is provided. The active energy ray curable composition includes a polymerization initiator and a polymerizable compound. When the active energy ray curable composition is formed into a film having an average thickness of 10 μm on a substrate and irradiated with an active energy ray until an accumulated amount of light becomes 300 mL/cm² to become a cured film, the cured film satisfies the following conditions (1) and (2):

(1) when the substrate is a polyethylene terephthalate substrate, the cured film on the substrate has a transmission density of from 1.5 to 3.0 that is measured with a transmission densitometer, and

(2) when the substrate is a polycarbonate substrate, the cured film on the substrate has a first length (L1) and a second length (L2) before and after a tensile test, respectively, and a ratio of the second length (L2) to the first length (L1) ranges from 1.5 to 4.0, wherein the tensile test includes forming the cured film on the substrate into a dumbbell-shaped specimen No. 6 defined in Japanese Industrial Standards K6251 and stretching the specimen with a tensile tester at a stretching speed of 20 mm/min and a temperature of 180° C.

In accordance with some embodiments of the present invention, a stereoscopic modeling material is provided. The stereoscopic modeling material includes the above active energy ray curable composition.

In accordance with some embodiments of the present invention, an active energy ray curable ink is provided. The active energy ray curable ink includes the above active energy ray curable composition,

In accordance with some embodiments of the present invention, an inkjet ink is provided. The inkjet ink includes the above active energy ray curable ink.

In accordance with some embodiments of the present invention, an active energy ray curable composition container is provided. The active energy ray curable composition container includes a container and the above active energy ray curable composition contained in the container.

In accordance with some embodiments of the present invention, a two-dimensional or three-dimensional image forming apparatus is provided. The two-dimensional or three-dimensional image forming apparatus includes an emitter and a container. The emitter emits an active energy ray to the above active energy ray curable composition. The container contains the above active energy ray curable composition.

In accordance with some embodiments of the present invention, a two-dimensional or three-dimensional image forming method is provided. The two-dimensional or three-dimensional image forming method includes emitting an active energy ray to the above active energy ray curable composition to cause the active energy ray composition to cure.

In accordance with some embodiments of the present invention, a cured product is provided. The cured product is produced by a method including emitting an active energy ray to the above active energy ray curable composition to cause the active energy ray composition to cure.

In accordance with some embodiments of the present invention, a processed product is provided. The processed product is produced by a method including stretching-processing or punching-processing the above cured product.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to an embodiment of the present invention;

FIG. 2 is a schematic view of an image forming apparatus according to an embodiment of the present invention; and

FIGS. 3A to 3D are illustrations for explaining optical modeling according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

The transmission density is an optical density defined by −log₁₀(I/I₀), wherein I represents a transmitted light quantity and I₀ represents an incident light quantity. In the present disclosure, the term “transmission density” and “optical density” have the same meaning and are exchangeable. “Optical density” may be abbreviated to “OD” for simplicity.

In a case in which a coated film of an active energy ray curable composition has a high transmission density, it is difficult for such a film to completely cure, causing defective curing in part. Defective curing results in insufficient stretchability of the cured product. On the other hand, the active energy ray curable composition generally includes monofunctional monomers in large amounts for giving stretchability to the cured product. However, the monofunctional monomers in large amounts cause defective curing due to their low curability, resulting in deterioration of adhesion and hardness of the cured product.

In particular, a coated film having black or yellow color, especially black color, is less ultraviolet-transmissive than that having another color. Therefore, as to a coated film of a black ink, defective curing is caused in the deep portion, causing deterioration of adhesion, hardness, and stretchability of the cured product.

In accordance with some embodiments of the present invention, an active energy ray curable composition having a good combination of high optical density and stretchability is provided.

### Active Energy Ray Curable Composition

The active energy ray curable composition according to an embodiment of the present invention includes a specific combination of a polymerizable compound and a polymerization initiator, thereby providing a cured product having a good combination of high transmission density and stretchability. The active energy ray curable composition is preferably used for inkjet inks that are required to have low viscosity.

### Polymerizable Compound

Polymerizable compounds generally refer to compounds which undergo a polymerization reaction by the action of active energy rays, such as ultraviolet ray and electron beam, to cure. The polymerizable compound according to an embodiment of the present invention includes both a monofunctional monomer and a polyfunctional monomer. In the present disclosure, monomers generally refer to polymerizable compounds which have not undergone a polymerizable reaction. The monomers are not limited in molecular weight.

### Monofunctional Monomer

The monofunctional monomer is not limited in its structure so long as it has one active energy ray polymerizable functional group in one molecule. Specific examples of such monofunctional monomer include, but are not limited to, N-vinyl-ε-caprolactam, dimethyl acrylamide, dimethyl methacrylamide, acryloyl morpholine, methacryloyl morpholine, hydroxyethyl acrylamide, hydroxyethyl methacrylamide, isobornyl acrylate, isobornyl methacrylate, dicyclopentyl acrylate, dicyclopentyl methacrylate, benzyl acrylate, benzyl methacrylate, tetrahydrofurfuryl acrylate, tetrahydrofurfuryl methacrylate, 3,3,5-trimethylcyclohexane acrylate, and 3,3,5-trimethylcyclohexane methacrylate.

Each of these monomers can be used alone or in combination with others. Preferably, the monofunctional monomer accounts for 75% by mass or more, more preferably 85% by mass or more, of the polymerizable compound in the active energy ray curable composition.

Specifically, non-bulky monofunctional monomers having a nitrogen-containing group (hereinafter “N group” for simplicity) are preferable for improving curability of the active energy ray curable composition. More specifically, acrylamide compounds, such as N-vinyl-ε-caprolactam, dimethyl acrylamide, dimethyl methacrylamide, acryloyl morpholine, and methacryloyl morpholine, are preferable, in particular, non-bulky monofunctional monomers having an N group preferably account for 25% to 95% by mass, more preferably 45% to 95% by mass, of the polymerizable compound.

As described above, the polymerizable compound may further include a polyfunctional monomer other than the monofunctional monomer.

### Polyfunctional Monomer

The polyfunctional monomer is not limited in its structure so long as it has two or more active energy ray polymerizable functional groups. Specific examples of the polyfunctional monomer include, but are not limited to, neopentyl glycol diacrylate, neopentyl glycol dimethacrylate, ethylene glycol diacrylate, ethylene glycol dimethacrylate, polyethylene glycol diacrylate, polyethylene glycol dimethacrylate, diethylene glycol diacrylate, diethylene glycol dimethacrylate, triethylene glycol diacrylate, triethylene glycol dimethacrylate, tetraethylene glycol acrylate, tetraethylene glycol dimethacrylate, polypropylene glycol diacrylate, polypropylene glycol dimethacrylate, tetramethylene glycol diacrylate, tetramethylene glycol dimethacrylate, polytetramethylene glycol diacrylate, polytetramethylene glycol dimethacrylate, propylene oxide (hereinafter “PO”) adduct of bisphenol A diacrylate, PO adduct of bisphenol A dimethacrylate, ethoxylated neopentyl glycol diacrylate, ethoxylated neopentyl glycol dimethacrylate, propoxylated neopentyl glycol diacrylate, propoxylated neopentyl glycol dimethacrylate, ethylene oxide (hereinafter “EO”) adduct of bisphenol A diacrylate, EO adduct of bisphenol A dimethacrylate, EO-modified pentaerythritol triacrylate. EO-modified pentaerythritol trimethacrylate, PO-modified pentaerythritol triacrylate, PO-modified pentaerythritol trimethacrylate, EO-modified pentaerythritol tetraacrylate, EO-modified pentaerythritol tetramethacrylate, PO-modified pentaerythritol tetraacrylate, PO-modified pentaerythritol tetramethacrylate, EO-modified di pentaerythritol tetraacrylate, EO-modified di pentaerythritol tetramethacrylate, PO-modified dipentaerythritol tetraacrylate, PO-modified dipentaerythritol tetramethacrylate, EO-modified trimethylolpropane triacrylate, EO-modified trimethylolpropane trimethacrylate, PO-modified trimethylolpropane triacrylate, PO-modified trimethylolpropane trimethacrylate, EO-modified tetramethylolmethane tetraacrylate, EO-modified tetramethylolmethane tetramethacrylate, PO-modified tetramethylolmethane tetraacrylate, PO-modified tetramethylolmethane tetramethacrylate, pentaerythritol triacrylate, pentaerythritol trimethacrylate, pentaerythritol tetraacrylate, pentaerythritol tetramethacrylate, dipentaerythritol tetraacrylate, dipentaerythritol tetramethacrylate, trimethylolpropane triacrylate, trimethylolpropane trimethacrylate, tetramethylolmethane tetraacrylate, tetramethylolmethane tetramethacrylate, trimethylolethane triacrylate, trimethylolethane trimethacrylate, trimethylolpropane triacrylate, trimethylolpropane trimethacrylate, bis(4-acryloxypolyethoxyphenyl)propane, bis(4-methacryloxypolyethoxyphenyl)propane, diallyl phthalate, triallyl trimellitate, 1,6-hexanediol diacrylate, 1,6-hexanediol dimethacrylate. 1,9-nonanediol diacrylate, 1,9-nonanediol dimethacrylate, 1,3-butylene glycol diacrylate, 1,3-butylene glycol dimethacrylate, 1,10-decanediol diacrylate, 1,10-decanediol dimethacrylate, hydroxypivalic acid neopentyl glycol diacrylate, hydroxypivalic acid neopentyl glycol dimethacrylate, tetramethylolmethane triacrylate, tetratnethylolmethane trimethacrylate dimethylol tricyclodecane diacrylate, dimethylol tricyclodecane dimethacrylate, modified glycerin triacrylate, modified glycerin trimethacrylate, bisphenol A glycidyl ether acrylic acid adduct, bisphenol A glycidyl ether methacrylic acid adduct, modified bisphenol A diacrylate, modified bisphenol A dimethacrylate, caprolactone-modified dipentaerythritol hexaacrylate, caprolactone-modified dipentaerythritol hexamethacrylate, dipentaerythritol hexaacrylate, dipentaerythritol hexamethacrylate, pentaerythritol triacrylate tolylene diisocyanate urethane polymer, pentaerythritol trimethacrylate tolylene diisocyanate urethane polymer, pentaerythritol triacrylate hexamethylene diisocyanate urethane polymer, pentaerythritol trimethacrylate hexamethylene diisocyanate urethane polymer, ditrimethylolpropane tetraacrylate, ditrimethylolpropane tetramethacrylate, pentaerythritol triacrylate hexamethylene diisocyanate urethane prepolymer, pentaerythritol trimethacrylate hexamethylene diisocyanate urethane prepolymer, urethane acrylate oligomer, epoxy acrylate oligomer, polyester acrylate oligomer, polyether acrylate oligomer, and silicone acrylate oligomer.

Each of these monomers can be used alone or in combination with others. Among these monomers, those having a functional group number of from 2 to 5 are preferable, and those having a functional group number of 2 are more preferable.

More specifically, urethane acrylate oligomer is preferable. Urethane acrylate oligomer is commercially available. Specific examples of commercially-available urethane acrylate oligomer include, but are not limited to, UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (available from The Nippon Synthetic Chemical Industry Co., Ltd.); CN929, CN961E75, CN961H81, CN962, CN963, CN963A80, CN963B80, CN963E75, CN963E80, CN963J85, CN965, CN965A80, CN966A80, CN966H90, CN966J75, CN968, CN981, CN981A75, CN981B88, CN982, CN982A75, CN982B88, CN982E75, CN983, CN985B88, CN9001, CN9002, CN9788, CN970A60, CN970E60, CN971, CN971A80, CN972, CN973A80, CN973H80, CN973J75, CN975, CN977C70, CN978, CN9782, CN9783, CN996, and CN9893 (available from Tomoe Engineering Co,, Ltd.); and EBECRYL 210, EBECRYL220, EBECRYL230, EBECRYL270, KRM/8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 (available from DAICEL-ALLNEX LTD.).

As the addition amount of the polyfunctional monomer becomes larger, and/or the molecular weight of the polyfunctional monomer becomes larger, the resulting ink viscosity becomes larger. The polyfunctional polymer preferably has a weight average molecular weight of 15,000 or less.

The content rate of the polyfunctional monomer in the polymerizable compound is preferably 30% by mass or less, more preferably from 2% to 20% by mass, and most preferably from 10% to 20% by mass. When the content rate of the polyfunctional monomer in the polymerizable compounds is in excess of 30% by mass, stretchability decreases or ink viscosity becomes extremely high. When used for inkjet inks, the content rate of the polyfunctional monomer in the polymerizable compounds is preferably 20% by mass or less.

In the present disclosure, weight average molecular weights are those converted from molecular weights of standard polystyrene samples, which are measured by a high-speed liquid chromatography system (including WATERS 2695 (main body) and WATERS 2414 (detector) available from Nihon Waters K. K.) equipped with in-line-three columns SHODEX GPCKF-806L (having an exclusion limit molecular weight of 2×10⁷, a separation range of from 100 to 2×10⁷, and a number of theoretical plates of 10,000; filled with a filler made of a styrene-divinylbenzene copolymer having a particle diameter of 10 μm).

### Active Energy Ray

Specific examples of the active energy include, but are not limited to, ultraviolet ray, electron beam, α-ray, β-ray, γ-ray, and X-ray. When a high-energy light source that emits electron beam, α-ray, β-ray, γ-ray, or X-ray is used, the polymerizable compound can undergo a polymerization reaction without the presence of a polymerization initiator. In the case of ultraviolet ray emission, the polymerizable compound can initiate a polymerization reaction owing to the presence of the photopolymerization initiator. The active energy ray curable composition according to an embodiment of the present invention is curable by the action of an active energy ray having a wavelength in UV-A region.

A typical active energy ray curable composition primarily composed of a. monofunctional monomer is curable by being formed into a film having a thickness of 10 μm and irradiated with with an active energy ray having a wavelength in UV-A region until the accumulated amount of light becomes 1,500 mJ/cm². By contrast, the active energy ray curable composition according to an embodiment of the present invention is curable by being irradiated with an active energy ray in UV-A region until the accumulated amount of light becomes about 300 mJ/cm².

### Polymerization Initiator

Examples of the polymerization initiator include, but are not limited to, molecular cleavage polymerization initiators, hydrogen atom abstraction polymerization initiators, and cationic polymerization initiators. For example, acrylate compounds, methacrylate compounds, acrylamide compounds, methacrylamide compounds, and vinyl ether compounds can be used as cationic polymerization initiators. It is to be noted that cationic polymerization initiators are generally expensive. In addition, cationic polymerization initiators need special care since they slightly generate a strong acid even when not being exposed to an active energy ray. For example, when the cationic polymerization initiator is used for an ink, an ink supply path for passing the ink in an image forming apparatus is preferably given acid resistance. In view of this situation, molecular cleavage polymerization initiators and hydrogen atom abstraction polymerization initiators are preferred when the active energy ray curable composition is to undergo a process including inkjet coating and ultraviolet ray emission.

Specific examples of the molecular cleavage polymerization initiators include, but are not limited to: alkylphenone compounds, such as 2,2-dimethoxy-1,2-diphenylethane-1-one, 1-hydroxycyclohexyl phenyl ketone, 2-hydroxy-2-methyl-1-phenylpropane-1-one, 1-[4-(2-hydroxyethoxy)-phenyl]-2-hydroxy-2-methyl-1-propane-1-one, 2-hydroxy-1-{4-[4-(2-hydroxy-2-methylpropionyl)benzyl]phenyl} -2-methyl-1-propane-1-one, oligo[2-hydroxy-2-methyl-1-1-[4-(1-methylvinyl)phenyl]propanone, phenylglyoxylic acid methyl ester, and bis(2,4,6-trimethylbenzoyl)phenylphosphine oxide; aminoalkylphenone compounds, such as 2-methyl-1-[4-(methylthio)phenyl]-2-morpholinopropane-1-one and 2-benzyl-2-dimethylamino-1-(4-morpholinophenyl)butanone-1, 2-dimethylamino-2-(4-methylbenzyl)-1-(4-morpholine-4-yl-phenyl)butane-1-one; acylphosphine oxide compounds, such as bis(2,6-dimethoxybenzoyl)-2,4,4-trimethyl-pentylphosphine oxide and 2,4,6-trimethylbenzoylphosphine oxide; oxime ester compounds, such as 1,2-octanedione-[4-(phenylthio)-2-(o-benzoyloxime)]and ethanone-1-[9-ethyl-6-(2-methylbenzoyl)-9H-carbazole-3-yl]-1-(O-acetyloxime); and benzophenone compounds such as [4-(methylphenylthio)phenyl]phenylmethanone.

Specific examples of hydrogen atom abstraction polymerization initiators include, but are not limited to: benzophenone compounds, such as benzophenone, methylbenzophenone, methyl-2-benzoyl benzoate, 4-benzoyl-4′-methyl diphenyl sulfide, phenylbenzophenone; and thioxanthone derivatives such as 2,4-diethylthioxanthone, 2-chlorothioxamhone, isopropylthioxanthone, and 1-chloro-4-propylthioxanthone.

It is generally considered that as the active energy ray transmittance of an active energy ray curable composition becomes smaller, the deep portion of the active enemy ray curable composition becomes less curable compared to the surface portion. Thus, for the purpose of improving overall curability, generally, an acylphosphine oxide polymerization initiator and a thioxanthone derivative are used in combination. The acylphosphine oxide polymerization initiator is capable of improving curability of the deep portion owing to its photobleaching effect, although the curing ability itself is not so good. The thioxanthone derivative, which is a sensitizer, is capable of improving curability of the surface portion.

On the other hand, the active energy ray curable composition according to an embodiment of the present invention has so small an active energy ray transmittance that the acylphosphine oxide polymerization initiator can exert a very small photobleaching effect thereon, resulting in a very small increase of the active energy ray transmittance. Thus, the active energy ray curable composition according to an embodiment of the present invention preferably includes an α-aminoalkylphenone polymerization initiator, having good curing ability, as a major polymerization initiator. In particular, the α-aminoalkylphenone polymerization initiator preferably accounts for 30% to 100% by mass of the polymerization initiator.

Preferably, the polymerization initiator includes an aminoalkylphenone compound in an amount of from 0% to 10% by mass, an acylphosphine oxide compound in an amount of from 0% to 10% by mass, and a thioxanthone derivative in an amount of from 0% to 5% by mass, based on total weight of the polymerization compound. More preferably, the polymerization initiator includes at least two of an aminoalkylphenone compound, an acylphosphine oxide compound, and a thioxanthone derivative. In particular, the polymerization initiator preferably includes an aminoalkylphenone compound in an amount of from 3% to 10% by mass, an acylphosphine oxide compound in an amount of from 0% to 5% by mass, and a thioxanthone derivative in an amount of from 1% to 3% by mass, based on total weight of the polymerization compound.

### Polymerization Accelerator

A polymerization accelerator, such as an amine compound, can be used in combination with the photopolymerization initiator.

Specific examples of the polymerization accelerator include, but are not limited to, ethyl p-dimethylaminobenzoate, 2-ethylhexyl p-dimethylaminobenzoate, methyl p-dimethylaminobenzoate, 2-dimethylaminoethyl benzoate, and butoxyethyl p-dimethylaminobenzoate.

### Other Components

The active energy ray curable composition according to an embodiment of the present invention may further include other components, if necessary. Examples of such components include a colorant, a polymerization inhibitor, a surfactant, a photosensitizes, a diluting solvent, and a pigment dispersant.

### Colorant

Various dyes and pigments can be used in view of physical properties of the active energy ray curable composition. Specific examples of the pigments include, but are not limited to, inorganic pigments and organic pigments, such as black pigments, yellow pigments, magenta pigments, cyan pigments, white pigments, and glossy color pigments (e.g., gold, silver). Preferably, the active energy ray curable composition according to an embodiment of the present invention includes a black pigment having a small active energy ray transmittance, for more efficiently exerting the effect of the present invention.

Specific examples of such black pigment include, but are not limited to, carbon blacks which are produced by furnace methods or channel methods.

In the case in which the colorant includes an inorganic pigment or an organic pigment, the pigment particles preferably have an average primary particle diameter of from 20 to 200 nm, more preferably from 50 to 160 nm, for achieving a proper transmission density (i.e., optical density (OD)).

The active energy ray curable composition according to an embodiment of the present invention may further include a polymerization inhibitor, a surfactant (e.g., higher-fatty-acid-based surfactant, silicone-based surfactant, fluorine-based surfactant), and/or a polar-group-containing polymeric pigment dispersant, if necessary. Specific examples of the polymerization inhibitor include, but are not limited to, 4-methoxy-1-naphthol, methyl hydroquinone, hydroquinone, t-butyl hydroquinone, di-t-butyl hydroquinone, methoquinone, 2,2′-dihydroxy-3,3′-di(α-methylcyclohexyl)-5,5′-dimethyldiphenylmethane, p-benzoquinone, di-t-butyl diphenyl amine, phenothiazine, 9,10-di-n-butoxyanthracene, and 4,4′-[1,10-dioxo-1,10-decanediyibis(oxy)]bis[2,2,6,6-tetramethyl]-1-piperidinyloxy.

### Properties of Active Energy Ray Curable Composition

### Viscosity

The viscosity of the active energy ray curable composition is adjusted in accordance with the purpose of use or application. When the active energy ray curable composition is applied to a distharge device that distharges the composition from nozzles, the composition is preferably diluted with an organic solvent.

Organic solvents having a boiling point of from 160° C. to 190° C. are preferably used for the dilution. Organic solvents having a boiling point greater than 200° C. may inhibit curing of the composition. Organic solvents having a boiling point less than 150° C. may be easily dried, causing the resulting ink to be solidified in nozzles of an inkjet apparatus.

Specific examples of usable organic solvents include, but are not limited to, ether, ketone, aromatic solvents, xylene, ethyl ethoxypropionate, ethyl acetate, cyclohexanone, diethylene glycol monomethyl ether, diethylene glycol monoethyl ether, γ-butyl lactone, ethyl lactate, cyclohexane methyl ethyl ketone, toluene, ethyl ethoxypropionate, polymethacrylate or propylene glycol monomethyl ether acetate, ethylene glycol monomethyl ether, diethylene glycol, and triethylene glycol monobutyl ether.

### Transmission Density

The transmission density (hereinafter “OD”) of the active energy ray curable composition depends on the particle diameter and the content of a pigment included therein. Generally, the smaller the particle diameter of the pigment, the larger the OD. In addition, generally, the larger the content of the pigment, the larger the OD.

In the case in which the colorant includes an inorganic pigment or an organic pigment, the pigment particles preferably have an average primary particle diameter of from 20 to 200 nm, more preferably from 50 to 160 rum When the average primary particle diameter is less than 20 nm, the pigment particles may lose dispersibility and aggregate,

When the average primary primary particle diameter is greater than 200 nm, the resulting print may have poor definition. The average primary particle diameter is measured using an electron microscope (JEM-2010 available from JEOL Ltd.)

When the active energy ray curable composition is formed into a film having an average thickness of 10 μm on a polyethylene terephthalate substrate and irradiated with an active energy ray until the accumulated amount of light becomes 300 mL/cm² to become a cured film, the cured film on the substrate has a transmission density of from 1.5 to 3.0 that is measured with a transmission densitometer.

### Stretchability

When the active energy ray curable composition is formed into a film having an average thickness of 10 μm on a polycarbonate substrate and irradiated with an active energy ray until the accumulated amount of light becomes 300 mL/cm² to become a cured film, the cured film on the substrate has a first length (L1) and a second length (L2) before and after a tensile test, respectively, and a ratio of the second length (L2) to the first length (L1) ranges from 1.5 to 4.0. In the tensile test, the cured film on the substrate is formed into a dumbbell-shaped specimen No. 6 defined in Japanese Industrial Standards K6251 and the specimen is stretched with a tensile tester at a stretching speed of 20 mm/min and a temperature of 180° C.

### Use Application

The active energy ray curable composition can be applied to, for example, modeling resins, paints, adhesives, insulating materials, release agents, coating materials, sealing materials, resists, and optical materials.

For example, the active energy ray curable composition can be applied to an active energy ray curable ink for forming two-dimensional texts and images. As another example, the active energy ray curable composition can be applied to a stereoscopic modeling material for forming a three-dimensional image (i.e., stereoscopic modeled object).

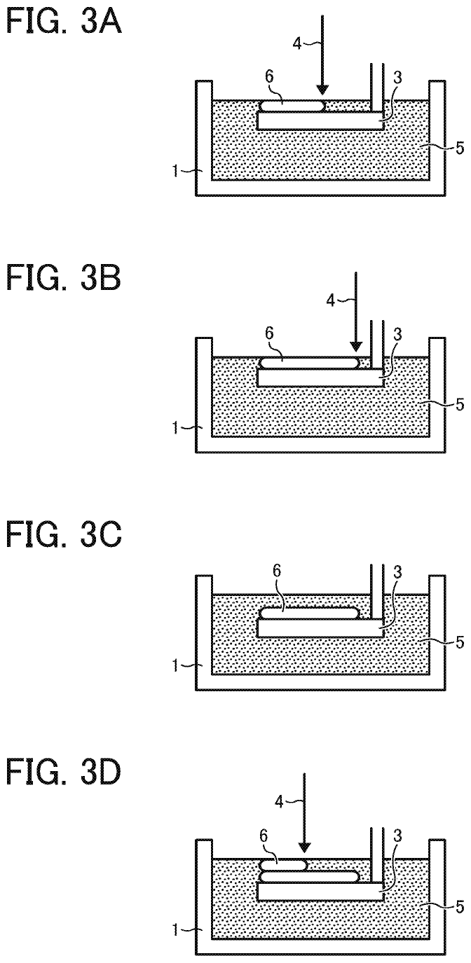

The stereoscopic modeling material can be applied to additive manufacturing, material jetting, and optical modeling, each of which is one of stereoscopic modeling processes. In additive manufacturing, the stereoscopic modeling material is used as a binder of powder particles. In material jetting, the stereoscopic modeling material is discharged to a certain region and exposed to an active energy ray to cure, and the cured layers are sequentially laminated to form a stereoscopic object, as described in detail later referring to FIG. 2. Optical modeling is described in detail later referring to FIGS. 3A to 3D.

Stereoscopic modeling apparatuses for forming stereoscopic modeled objects with the active energy ray curable composition are not limited in structure and may include a storage for storing the active energy ray curable composition, a supplier, a discharger, and an active energy ray emitter.

### Active Energy Ray Curable Composition Container

The active energy ray curable composition container according to an embodiment of the present invention includes a container and the above-described active energy ray curable composition contained in the container.

When the active energy ray curable composition is used for an ink, the active energy ray curable composition container serves as an ink cartridge or an ink bottle, which prevents user from directly contacting the ink when the user is replacing the ink, thus preventing user's fingers and clothes from being contaminated with the ink. In addition, the ink cartridge or ink bottle prevents foreign substances from being mixed into the ink. The container is not limited in shape, size, and material. Preferably, the container is made of a light-blocking material.

### Two-dimensional or Three-dimensional Image Forming Method and Apparatus

A two-dimensional or three-dimensional image forming method according to an embodiment of the present invention includes at least the step of emitting an active energy ray to the active energy ray curable composition to cause the active energy ray curable composition to cure. A two-dimensional or three-dimensional image forming apparatus according to an embodiment of the present invention includes at least an emitter to emit an active energy ray to the active energy ray curable composition and a container to contain the active energy ray curable composition. The container included in the two-dimensional or three-dimensional image forming apparatus may be the above-described active energy ray curable composition container. The two-dimensional or three-dimensional image forming method may further include the step of discharging the active energy ray curable composition. The two-dimensional or three-dimensional image forming apparatus may further include a. discharger to discharge the active energy ray curable composition. The discharging method may be of a continuous injection type or an on-demand type, but is not limited thereto. Specific examples of the on-demand-type discharging method include thermal methods and electrostatic methods.

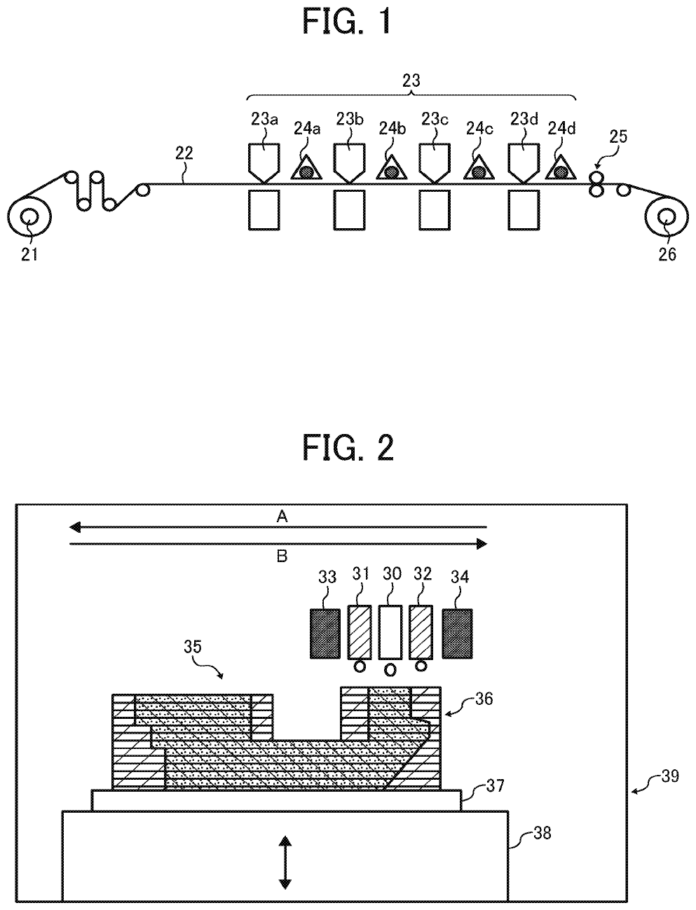

FIG. 1 is a schematic view of an image forming apparatus according to an embodiment of the present invention, which includes an inkjet discharger. The image forming apparatus illustrated in FIG. 1 includes printing units 23a, 23b, 23c, and 23d and a supply roller 21. Each of the printing units 23a, 23b, 23c, and 23d includes an ink cartridge containing an active energy ray curable inkjet ink having yellow, magenta, cyan, and black colors, respectively, and a discharge head. The inks are discharged to a recording medium 22 supplied by the supply roller 21. Light sources 24a, 24b, 24c, and 24d emit active energy rays to the respective inks on the recording medium 22 to cause the inks to cure and form color images. The recording medium 22 is then conveyed to a winding roller 26 via a processing unit 25. Each of the printing units 23a, 23b, 23c, and 23d may be equipped with a heater for liquefying the ink at the inkjet discharger. Furthermore, the printing units 23a, 23b, 23c, and 23d may be equipped with a cooler for cooling the recording medium to room temperature with or without contacting the recording medium. The image forming apparatus illustrated in FIG. 1 may be an inkjet recording apparatus employing a serial method or a line method. In the serial method, ink is discharged from a moving discharge head onto a recording medium that is intermittently moved in accordance with the width of the discharge head. In the line method, ink is discharged from a fixed discharge head onto a recording medium that is continuously moved.

Specific preferred materials for the recording medium 22 include, but are not limited to, paper, film, metal, and composite materials thereof, which may be in the form of a sheet. The image forming apparatus illustrated in FIG. 1 may be capable of either one-side printing or duplex printing.

It is possible that the light sources 24a, 24b, and 24c emit weakened active energy rays or no active energy ray and the light source 24d emits an active energy ray after multiple color images have been printed. In this case, energy consumption and cost are reduced.

Recorded matters recorded by the ink according to an embodiment of the present invention include those printed on smooth surfaces such as normal paper and resin films, those printed on irregular surfaces, and those printed on surfaces of various materials such as metal and ceramics. By laminating two-dimensional images, a partially-stereoscopic image (including two-dimensional parts and three-dimensional parts) or a stereoscopic product can be obtained.

FIG. 2 is a schematic view of a three-dimensional image forming apparatus according to another embodiment of the present invention. Referring to FIG. 2, an image forming apparatus 39 includes a discharge head unit 30 for forming modeled object layers, discharge head units 31 and 32 for forming support layers, and ultraviolet emitters 33 and 34 adjacent to the discharge head units 30, 31, and 32. Each of the discharge head units 30, 31, and 32 includes an inkjet head and is movable in the directions indicated by arrows A and B in

FIG. 2. The discharge head unit 30 discharges a first active energy ray curable composition, and the discharge head units 31 and 32 each discharge a second active energy ray curable composition different from the first active energy ray curable composition. The ultraviolet emitters 33 and 34 cause the active energy ray curable compositions to cure. The cured products are laminated in the image forming apparatus 39. More specifically, first, the second active energy ray curable composition is discharged from the discharge head units 31 and 32 onto a modeled object supporting substrate 37 and exposed to an active energy ray to cure, thus forming a first support layer having a reservoir. Next, the first active energy ray curable composition is discharged from the discharge head unit 30 onto the reservoir and exposed to an active energy ray to cure, thus forming a first modeled object layer. These processes are repeated multiple times, in accordance with the set number of lamination, while lowering a stage 38 that is movable in the vertical direction, to laminate the support layers and the modeled object layers. Thus, a stereoscopic modeled object 35 is obtained. A support layer lamination 36 is removed thereafter, if necessary. In the embodiment illustrated in FIG. 2, the number of discharge head unit 30 for forming modeled object layers is one. Alternatively, the number thereof may be two or more.

FIGS. 3A to 3D are illustration for explaining optical modeling, which is one example of a three-dimensional image forming method according to an embodiment of the present invention. Referring to FIGS. 3A to 3D, a stereoscopic modeling material 5 is retained in a pool I and exposed to an active energy ray 4 to be formed into a cured layer 6 on a movable stage 3, and the cured layers 6 are sequentially laminated to form a stereoscopic object.

### Cured Product and Processed Product

The cured product according to an embodiment of the present invention is obtainable by causing the active energy ray curable composition to cure. The processed product according to an embodiment of the present invention is obtainable by processing the cured product formed on a substrate, such as a recording medium.

More specifically, the cured product according to an embodiment of the present invention is obtainable by causing the active energy ray curable composition to cure by the action of an active energy ray. For example, the cured product can be obtained by forming a coated film (image) of the active energy ray curable composition on a substrate by an inkjet discharge device and emitting ultraviolet ray to the coated film formed on the substrate to cause the coated film to rapidly cure. More preferably, an active energy ray having a wavelength in UV-A region is emitted until the accumulate amount of light becomes 300 mL/cm²,

The cured product according to an embodiment of the present invention satisfies the above-described conditions (1) and (2).

Specific examples of the substrate for use in forming the cured product include, but are not limited to, paper, plastic, metals, ceramics, glass, and composite materials thereof.

Among these materials, plastic substrates are preferable in terms of processability. In particular, plastic films and plastic moldings are preferable, which may be made of polyethylene, polypropylene, polyethylene terephthalate, polycarbonate, ABS (acrylonitrile butadiene styrene) resin, polyvinyl chloride, polystyrene, polyester, polyamide, vinyl materials, acrylic resin, and composite materials thereof.

The processed product according to an embodiment of the present invention is obtainable by processing (e.g., stretching-processing or punching-processing) a surface-decorated article of the cured product formed on the substrate.

The processed product is preferably used for meters and operation panels of automobiles, office automation equipments, electric or electronic devices, and cameras, which typically need to be surface-decorated.

### EXAMPLES

Having generally described this invention, further understanding can be obtained by reference to certain specific examples which are provided herein for the purpose of illustration only and are not intended to be limiting.

### Examples 1 to 10 and Comparative Examples 1 to 4

The below-listed materials were mixed according to the blending ratios described in Tables 1 to 3 (numerical values represent parts by weight), thus preparing inks of Examples 1 to 10 and Comparative Examples 1 to 4.

Details of A1 to A6, B1 to B7, C1 to C3, D1, and E1 described in Tables 1 to 3 are as follows. In particular, A1 to A6 are polymerization initiators, B1 to B7 are monofunctional monomers, and C1 to C3 are polyfunctional monomers.
A1: 2-(4-Methylbenzyl)-2-(dimethylamino)-1-(4-morpholinophenyl)butane-1-one
A2: Bis(2,4,6-trimethylbenzoyl)-phenylphosphine oxide
A3: 2,4-Diethylthioxanthene-9-one
A4: 1-Hydroxy-cyclohexyl-phenyl-ketone
A5: Bis(η5,2,4-cyclopentadiene-1-yl)-bis(2,6-difluoro-3-(1H-pyrrol-1-yl)-phenyl)titanium
A6: Ethanone, 1-[9-ethyl-6-(2-methylbenzoyl)-9H-carbazole-3-yl]-,1-(0-acetyloxime)
B1: Acryloyl morpholine
B2: Dimethylacrylamide
B3: Benzyl acrylate
B4: Tetrahydrofurfuryl acrylate
B5: Isobornyl acrylate
B6: Adamantyl acrylate
B7: Dicyclopentanyl acrylate
C1: Diethylene glycol diacrylate
C2: 1,9-Nonanediol diacrylate
C3: Urethane acrylate oligomer
D1: Tertiary butyl hydroquinone
E1: Carbon Black (having an average primary particle diameter of from 30 to 33 nm)

Each ink was applied to the whole surface of a substrate with a bar coater #6 (available from Kobayashi Engineering Works., Ltd.) to be formed into a solid coated film having a thickness of about 10 μm.

As the substrate, a polycarbonate (PC) film (lupilon® 100FE2000 Masking, having a thickness of 100 μm, available from Mitsubishi Engineering-Plastics Corporation), a polyethylene terephthalate (PET) film (E5100#100, having a thickness of 100 μm, available from TOYOBO CO., LTD.), and a polypropylene film were used.

Each solid coated films formed on the substrates were exposed to an active energy ray having a wavelength in UV-A region (i.e., from 350 to 400 nm) emitted from a UV emitter (LH6D Bulb available from Fusion UV Systems Japan K. K.) until the accumulated amount of light had become 300 mJ/cm². The resulting cured films were subjected to the following evaluations.

### Evaluation of Stretchability

The cured films formed on the polycarbonate film substratessubjected to an evaluation of stretchability.

Specifically, each cured film on the substrate was formed into a dumbbell-shaped specimen (No. 6) defined in MS (Japanese Industrial Standards) K6251, and subjected to a tensile test performed with a tensile tester (AUTOGRAPH AGS-5kNX available from Shimadzu Corporation) while setting the stretching speed to 20 mm/min and the temperature to 180° C. Stretchability was determined by a ratio L2/L1, wherein L1 represents a first length of a specimen before the tensile test and L2 represents a second length of the specimen after the tensile test.

### Evaluation of Transmission Density

The cured films, having a thickness of 10 μm, formed on the polyethylene terephthalate film substrates were subjected to a measurement of transmission density using a transmission densitometer (available from X-Rite Inc.

### Evaluation of Curability in Deep Portion

The cured films formed on the polypropylene films were transferred onto a piece of an adhesive cellophane tape and peeled off from the film. The peeled surfaces of the cured films were subject to determination of the degree of tackiness,

Each ink was subjected to the evaluations of stretchability, transmission density, and curability in the deep portion. Evaluation results are shown in Tables 1 to 3. Evaluation criteria are as follows.

Stretchability
A+:L2/L1>2.5
A: 2.5>L2/L1>20
B: 2.0>L2/L1>1.5
C: 1.5>L2/L1

Transmission Density
A: OD>1.5
B: 1.0<OD<1.5
C: 1.0>OD

Curability in Deep Portion
A: The peeled surface of the cured film has no tackiness.
B: The peeled surface of the cured film has tackiness.
C: Not cured.

TABLE 1

| Raw | Example | Example | Example | Example | Example |
|---|---|---|---|---|---|
| Materials | 1 | 2 | 3 | 4 | 5 |
| A1 | 3 | | | 5 | 3 |
| A2 | 5 | | 7 | 5 | 5 |
| A3 | 2 | | 3 | 5 | 2 |
| A4 | | 3 | | | |
| A5 | | 3 | | | |
| A6 | | 3 | | | |
| B1 | | 44 | 22 | 22 | |
| B2 | | 44 | 22 | 22 | |
| B3 | 44 | | 22 | 22 | 44 |
| B4 | 44 | | 22 | 22 | 44 |
| B5 | | | | | |
| B6 | | | | | |
| B7 | | | | | |
| C1 | | | 2 | | 2 |
| C2 | 2 | 2 | | 2 | |
| C3 | 10 | 10 | 10 | 10 | 10 |
| D1 | 0.1 | 0.1 | 0.1 | 0.1 | 0.1 |
| E1 | 4.5 | 4.5 | 4.5 | 4.5 | 4.5 |
| Stretchability | B | B | B | B | A |
| Transmission | A | A | A | A | A |
| Density | | | | | |
| Curability in | B | B | B | B | A |
| Deep Portion | | | | | |

TABLE 2

| Raw | Example | Example | Example | Example | Example |
|---|---|---|---|---|---|
| Materials | 6 | 7 | 8 | 9 | 10 |
| A1 | 10 | 7 | 3 | 10 | 7 |
| A2 | 0 | 1 | 5 | 0 | 1 |
| A3 | 1 | 3 | 2 | 1 | 3 |
| A4 | | | | | |
| A5 | | | | | |
| A6 | | | | | |
| B1 | | | 44 | 44 | 44 |
| B2 | | | 44 | 44 | 44 |
| B3 | 44 | 44 | | | |
| B4 | 44 | 44 | | | |
| B5 | | | | | |
| B6 | | | | | |
| B7 | | | | | |
| C1 | | 2 | | 2 | |
| C2 | 2 | | 2 | | 2 |
| C3 | 10 | 10 | 10 | 10 | 10 |
| D1 | 0.1 | 0.1 | 0.1 | 0.1 | 0.1 |
| E1 | 4.5 | 4.5 | 4.5 | 4.5 | 4.5 |
| Stretchability | A | A | A+ | A+ | A+ |
| Transmission | A | A | A | A | A |
| Density | | | | | |
| Curability in | A | A | A+ | A+ | A+ |
| Deep Portion | | | | | |

TABLE 3

| Raw | Comparative | Comparative | Comparative | Comparative |
|---|---|---|---|---|
| Materials | Example 1 | Example 2 | Example 3 | Example 4 |
| A1 | | 3 | 3 | |
| A2 | | 5 | 5 | |
| A3 | | 2 | 2 | |
| A4 | 3 | | | 3 |
| A5 | 3 | | | 3 |
| A6 | 3 | | | 3 |
| B1 | | 35 | 35 | 44 |
| B2 | | 35 | 35 | 44 |
| B3 | 44 | | | |
| B4 | | | | |
| B5 | 15 | | | |
| B6 | 14 | | | |
| B7 | 15 | | | |
| C1 | 2 | 10 | | 2 |
| C2 | | 10 | 7 | |
| C3 | 10 | 10 | 28 | 10 |
| D1 | 0.1 | 0.1 | 0.1 | 0.1 |
| E1 | 4.5 | 4.5 | 4.5 | 2 |
| Stretchability | C | C | C | A |
| Transmission | A | A | A | C |
| Density | | | | |
| Curability in | C | C | C | A |
| Deep Portion | | | | |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1-17. (canceled)

18. An active energy ray curable composition, comprising:
a polymerization initiator;
a polymerizable compound; and
a black pigment,
wherein the polymerizable compound comprises at least one monofunctional monomer and at least one polyfunctional monomer and/or polyfunctional oligomer,
wherein the polymerization initiator includes at least two members selected from the group consisting of an aminoalkylphenone compound, an acylphosphine oxide compound, and a thioxanthone derivative,
wherein the monofunctional monomer comprises at least one acrylamide compound selected from the group consisting of acryloyl morpholine and methacryloyl morpholine,
wherein, when the active energy ray curable composition is formed into a film having an average thickness of 10 μm on a substrate and irradiated active energy ray until an accumulated amount of light becomes 300 mL/cm² to become a cured film, the cured film satisfies the following conditions (1) and (2):
(1) when the substrate is a polyethylene terephthalate substrate, the cured film on the substrate has a transmission density of from 1.5 to 3.0 that is measured with a transmission densitometer, and
(2) when the substrate is a polycarbonate substrate, the cured film on the substrate has a first length (L1) and a second length (L2) before and after a tensile test, respectively, and a ratio of the second length (L2) to the first length (L1) ranges from 1.5 to 4.0, wherein the tensile test includes forming the cured film on the substrate into a dumbbell-shaped specimen No. 6 defined in Japanese Industrial Standards K6251 and stretching the specimen with a tensile tester at a stretching speed of 20 mm/min and a temperature of 180° C.

19. The active energy ray curable composition of claim 18, wherein the monofunctional monomer accounts for 75% by mass or more of the polymerizable compound.

20. The active energy ray curable composition of claim 18, wherein the monofunctional monomer includes acryloyl morpholine.

21. The active energy ray curable composition of claim 18, wherein the polymerization initiator includes:
the aininoalkylphenone compound in an amount of from 3% to 10% by mass based on a total weight of the polymerizable compound;
the acylphosphine oxide compound in an amount of from 0% to 5% by mass based on the total weight of the polymerizable compound; and
the thioxanthone derivative in an amount of from 1% to 3% by mass based on the total weight of the polymerizable compound.

22. The active energy ray curable composition of claim 18, wherein the at least one acrylamide compound accounts for 25% by mass or more of the polymerizable compound.

23. An active energy ray curable composition container, comprising:
a container; and
the active energy ray curable composition of claim 18 contained in the container.

24. A two-dimensional or three-dimensional image forming apparatus, comprising:
an emitter to emit an active energy ray to the active energy ray curable composition of claim 18; and
a container to contain the active energy ray curable composition.

25. A two-dimensional or three-dimensional image forming method, comprising:
emitting an active energy ray to the active energy ray curable composition of claim 18 to cause the active energy ray composition to cure.

26. The two-dimensional or three-dimensional image forming method of claim 25.
wherein the method is a two-dimensional image forming method, and
wherein the active energy ray has a wavelength in UV-A region and an accumulated amount of the emitted active energy ray is 300 mJ/cm².

27. A cured product, produced by a method comprising:
emitting an active energy ray to the active energy ray curable composition of claim 18 to cause the active energy ray composition to cure.

28. A processed product, produced by a method comprising:
stretching-processing or punching-processing the cured product of claim 27.

29. An active energy ray curable composition, comprising:
a polymerization initiator;
a polymerizable compound; and
a black pigment,
wherein the polymerizable compound comprises at least one monofunctional monomer and at least one polyfunctional monomer and/or polyfunctional oligomer,
wherein the polymerization initiator includes at least two members selected from the group consisting of an aminoalkylphenone compound, an acylphosphine oxide compound, and a thioxanthone derivative,
wherein the monofunctional monomer is at least one selected from the group consisting of dimethyl acrylamide, dimethyl methacrylamide, hydroxyethyl acrylamide, hydroxyethyl methacrylamide,
wherein, when the active energy ray curable composition is formed into a film having an average thickness of 10 μm on a substrate and irradiated with an active energy ray until an accumulated amount of light becomes 300 mL/cm² to become a cured film, the cured film satisfies the following conditions (1) and (2):
(1) when the substrate is a polyethylene terephthalate substrate, the cured film on the substrate has a transmission density of from 1.5 to 3.0 that is measured with a transmission densitometer, and
(2) when the substrate is a polycarbonate substrate, the cured film on the substrate has a first length (L1) and a second length (L2) before and after a tensile test, respectively, and a ratio of the second length (L2) to the first length (L1) ranges from 1.5 to 4.0, wherein the tensile test includes forming the cured film on the substrate into a dumbbell-shaped specimen No. 6 defined in Japanese Industrial Standards K6251 and stretching the specimen with a tensile tester at a stretching speed of 20 mm/min and a temperature of 180° C.

30. The active energy ray curable composition of claim 18, wherein the polyfunctional monomer and the polyfunctional oligomer account for 2% to 20% by mass of the polymerizable compound.

31. The active energy ray curable composition of claim 29, wherein the polyfunctional monomer and the polyfunctional oligomer account for 2% to 20% by mass of the polymerizable compound.

32. The active energy ray curable composition of claim 30, wherein the polyfunctional oligomer includes a urethane acrylate oligomer.

33. The active energy ray curable composition of claim 31, wherein the polyfunctional oligomer includes a urethane acrylate oligomer.

34. The active energy ray curable composition of claim 18, wherein the polyfunctional monomer and the polyfunctional oligomer account for 2% to 20% by mass of the polymerizable compound, and
wherein the monofunctional monomer accounts for 75% by mass or more of the polymerizable compound.

35. The active energy ray curable composition of claim 29, wherein the polyfunctional monomer and the polyfunctional oligomer account for 2% to 20% by mass of the polymerizable compound, and
wherein the monofunctional monomer accounts for 75% by mass or more of the polymerizable compound.
